(19) United States
(12) Patent Application Publication
(10) Pub. No.: US 2021/0003083 A1
(43) Pub. Date: Jan. 7, 2021

(54) DYNAMIC CONTROL OF AN AIR HANDLING SYSTEM FOR VEHICLE ACCELERATION PERFORMANCE

(71) Applicant: Cummins Inc., Columbus, IN (US)

(72) Inventor: Steven M. Bellinger, Columbus, IN (US)

(21) Appl. No.: 17/026,722

(22) Filed: Sep. 21, 2020

Related U.S. Application Data
(63) Continuation of application No. PCT/US2019/021102, filed on Mar. 7, 2019.
(60) Provisional application No. 62/648,037, filed on Mar. 26, 2018.

(51) Int. Cl. F02D 41/00; F02D 41/14; F02B 37/22

(52) U.S. Cl. CPC F02D 41/0007; F02D 41/1401; F02B 37/225; F02D 2041/141; F02D 2200/0618; F02D 2200/501; F02D 2200/602; F02D 2200/0404

(57) ABSTRACT

System, apparatus, and methods are disclosed for improving vehicle acceleration performance. One or more devices of the internal combustion engine system are controlled in response to a torque transition event indicator and/or one or more vehicle acceleration event indicators indicating a vehicle acceleration event is imminent to improve vehicle response during acceleration.

### CROSS-REFERENCE TO RELATED APPLICATIONS

The present application is a continuation of International Application No. PCT/US19/21102 filed on Mar. 7, 2019, which claims the benefit of the filing date of U.S. Provisional App. Ser. No. 62/648,037 filed on Mar. 26, 2018, which are incorporated herein by reference in their entirety.

### BACKGROUND

The present application generally relates to dynamic control of one or more devices of an internal combustion engine for vehicle acceleration performance, and more particularly to methods, systems and apparatus for controlling the devices to improve acceleration performance in response to a vehicle launch indication.

In certain engine operating conditions, desired emission and/or efficiency limits can be violated due to transients, disturbances, and/or other variations in the engine system. For example, the air handling system of an engine can be controlled to maximize efficiency and minimize emissions during idle conditions. However, existing approaches in maintaining desired efficiency and emissions limits do not provide adequate air handling control and/or other system responses to facilitate vehicle launch, degrading vehicle performance during acceleration. Therefore, a need remains for further improvements in systems, apparatus, and methods for controlling one or more devices of a vehicle to improve acceleration performance.

### SUMMARY

Embodiments include a unique system, method, and/or apparatus including adjusting one or more references that control one or more devices of an internal combustion engine system in response to a vehicle acceleration event indicator and/or torque transition event indicating that vehicle acceleration and/or torque transition is imminent.

This summary is not intended to identify key or essential features of the claimed subject matter, nor is it intended to be used as an aid in limiting the scope of the claimed subject matter. Further embodiments, forms, objects, features, advantages, aspects, and benefits shall become apparent from the following description and drawings.

### BRIEF DESCRIPTION OF THE DRAWINGS

FIG. 1 is a schematic illustration of a system including an example internal combustion engine system for a vehicle.

FIG. 2 is a schematic illustration of a cylinder of the internal combustion engine of FIG. 1.

FIG. 3 is a diagram illustrating an example controller apparatus of the system of FIG. 1.

FIG. 4 is a flow diagram of a procedure that can be performed in conjunction with controlling one or more devices in response to a vehicle acceleration and/or torque transition event for the system of FIG. 1.

### DESCRIPTION OF ILLUSTRATIVE EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended, any alterations and further modifications in the illustrated embodiments, and any further applications of the principles of the invention as illustrated therein as would normally occur to one skilled in the art to which the invention relates are contemplated herein.

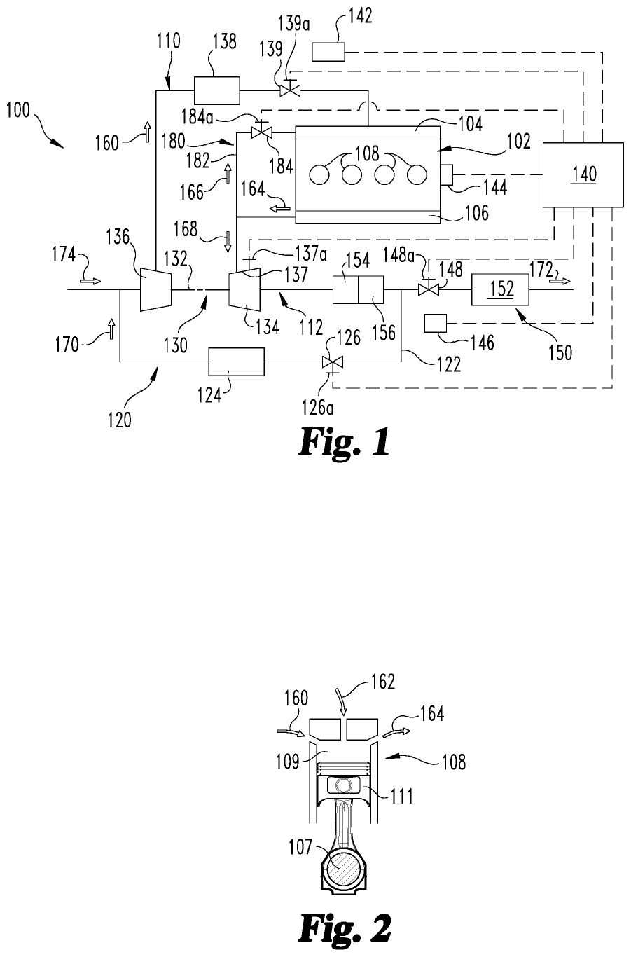

With reference to FIG. 1, there is illustrated an internal combustion engine system 100 that includes an internal combustion engine 102 in fluid communication with an intake system 110. A charge flow 160 enters an intake manifold 104 of the engine 102, and an exhaust flow 164 from combustion in engine 102 exits via an exhaust system 112 that includes an exhaust manifold 106 of the engine 102, it being understood that not all details of these systems that are typically present are shown. Engine 102 includes a number of cylinders 108 forming combustion chambers 109 (FIG. 2) into which fuel flow 162 is injected by a fuel injector device or devices (not shown) to combust with the charge flow 160 that has entered through the intake system 110 to the intake manifold 104.

As shown in FIG. 2, intake valves (not shown) control the admission of a charge flow 160 into the combustion chamber 109 of each of the cylinders 108. A piston 111 is housed in the combustion chamber 109 and is operable to move up and down in cylinder 108 to drive a crankshaft 107 in response to combustion of fuel flow 162 and charge flow 160 in combustion chamber 109. Exhaust valves (not shown) control the outflow of exhaust flow 164 from the combustion chambers 109 through exhaust system 112 and ultimately to the atmosphere. In some embodiments, the cylinders 108 may include a spark plug or other ignition device (not shown) to ignite the charge flow.

The internal combustion engine system 100 further includes a turbocharger 130, such as a fixed geometry turbocharger including a wastegate, or a variable geometry turbocharger (VGT), for example. Turbocharger 130 is operable to compress ambient air and, as discussed further below, low pressure (LP) exhaust gas recirculation (EGR) flow 170 before the ambient air and LP EGR flow 170 (if provided) enters the intake manifold 104 of the engine 102 at increased pressure. The turbocharger 130 includes a shaft 132 connecting a turbine 134 connected to the exhaust system 112 and a compressor 136 connected to the intake system 110. The air handling system 100 further includes a charge air cooler (CAC) 138, operable to cool the charge flow 160 provided to intake manifold 104. The internal combustion engine system 100 may also include an intake throttle 139 downstream of CAC 138 to assist in control of the charge flow 160 to intake manifold 104. Other embodiments may include bypass (not shown) around CAC 138 and/or a bypass (now shown) around compressor 136 and/or various other components not shown.

The internal combustion engine system 100 may also include a LP EGR loop 120, including an EGR conduit 122 connecting the intake system 110 and the exhaust system 112 downstream of turbine 134 and upstream of compressor 136. ALP EGR valve 126 is provided for controlling the LP EGR flow 170 from the exhaust system 112 to the intake system 110 through LP EGR conduit 122, and a LP EGR cooler 124 is provided for cooling the LP EGR flow 170 before it is mixed with a fresh air flow 174 upstream of or at the inlet of compressor 136. It is contemplated that in certain embodiments the cooler 124 may not be present and/or a controllable bypass is provided to bypass all or a portion of the LP EGR flow 170 around LP EGR cooler 124.

The internal combustion engine system 100 may also include a high pressure (HP) EGR loop 180, including a HP EGR conduit 182 connecting the intake system 110 and the exhaust system 112 upstream of turbine 134 and downstream of compressor 136. A HP EGR valve 184 is provided for controlling the HP EGR flow 166 from the exhaust system 112 to the intake manifold 104 of intake system 110 through HP EGR conduit 182 for mixing with the compressed combined LP EGR flow 170 (if any) and fresh air flow 174 from compressor 136. The mixture of fresh air flow 174 and any LP EGR flow 170 from compressor 136 is pumped through the intake system 110, to the intake manifold 104 for mixing with any HP EGR flow 166 to provide the charge flow 160 into the engine cylinders 108, typically producing torque on the crankshaft 107. The portion 168 of the exhaust flow 164 not recirculated as HP EGR flow 168 is provided to turbine 134, and the part of the portion 168 of exhaust flow 164 that passes through turbine 134 that is not recirculated as LP EGR flow 170 is provided as exhaust outflow 172 to an aftertreatment system 150.

It shall be appreciated that the internal combustion engine system 100 is but one non-limiting illustrative embodiment of an internal combustion engine system to which the principles and techniques disclosed herein may be applied. A variety of alternate system configurations and components may be utilized including, for example, systems with and without turbochargers, with multiple turbochargers, or other types of superchargers, including electrically operated turbo and superchargers. Exemplary forced induction systems may include one or more variable geometry turbochargers (VGTs), fixed geometry turbochargers, wastegated turbochargers, twin-turbochargers, series or parallel configurations of multiple turbochargers, symmetric or asymmetric combinations of turbochargers, and/or superchargers.

It shall be further appreciated that exemplary internal combustion engine systems may include charge air coolers with or without charge air cooler bypass valves, intake throttle valves, exhaust throttle valves, EGR valves, compressor bypass valves and/or as other types of air-handling actuators. A variety of EGR systems and configurations may be utilized including, for example, low pressure loop EGR, high pressure loop EGR, direct EGR, and/or EGR dedicated to one or more cylinders. Certain embodiments may include EGR loops with hot side EGR valves or cold side EGR valves. Certain embodiments may comprise systems including EGR bypass valves. Some embodiments may comprise non-EGR systems which omit EGR structure and functionality. For example, in some embodiments only one of LP EGR loop 120 and HP EGR loop 180 is provided.

In one embodiment, aftertreatment system 150 includes an SCR catalyst 152 downstream of an exhaust throttle 148. Exhaust throttle 148 is located downstream of LP EGR loop 120. Aftertreatment system 150 may further include an oxidation catalyst 154 and a particulate filter 156 upstream of LP EGR loop 120 and SCR catalyst 152, and downstream of turbine 134. Reductant injection may also be provided between the oxidation catalyst 154 and particulate filter 156, and/or upstream of SCR catalyst 152. Other aftertreatment components may also be provided and are not limited to those shown. In addition one or more of the shown aftertreatment components can be omitted or re-positioned from what is shown in FIG. 1.

In the illustrated embodiment, the internal combustion engine system 100 includes one or more air handling sensors 142. Example air handling sensors 142 may include a mass air flow (MAF) sensor, an ambient air temperature sensor, an ambient air pressure sensor, and an intake pressure sensor, each associated with the intake system 110. The air handling sensor(s) 142 may also include an intake manifold pressure (IMAP) sensor in fluid communication with the intake manifold 104 or any other position within the intake system 110 or the intake manifold 104. Air handling sensors 142 can be at any location that provides a suitable indication of applicable intake system 110 and intake manifold 104 readings.

In one embodiment, the air handling sensors 142 include an IMAP sensor that is operative to sense the air pressure in the intake manifold 104, and the MAF sensor is operative to sense the flow rate of air entering the engine 102, which can be utilized to calculate an EGR fraction. The EGR fraction provides an indication of the amount of LP EGR flow 170 and/or HP EGR flow 166 being supplied to the intake manifold 104 relative to the fresh air flow 174. However, any suitable method for determining the EGR fraction is contemplated.

The engine 102 may further include a number of engine sensors 144, such as an engine speed sensor, fuel sensors, and pedal (service brake and/or accelerator) position sensors. The internal combustion engine system 100 may further include a number of exhaust sensors 146, such as an oxygen sensor and/or a NOx sensor in fluid communication with the exhaust system 112, and an exhaust manifold pressure sensor in fluid communication with the exhaust manifold 106. The oxygen sensor is operable to provide a measurement of the level or amount of oxygen in the exhaust flow 164 from engine 102. The oxygen sensor may be a true oxygen sensor, lambda sensor, or any type of sensor from which the oxygen level in the exhaust gas can be determined. The NOx sensor is operable to provide a measurement of the amount or level of NOx in the exhaust flow 164 from engine 102. Each of the oxygen sensor, the NOx sensor, and the exhaust manifold pressure sensor need not be in direct communication with the exhaust system 112 or exhaust manifold 106, and can be located at any position within the exhaust system 112 or exhaust manifold 106 that provides a suitable indication of applicable exhaust system 112 or exhaust manifold 106 readings. In certain embodiments, the oxygen sensor and NOx sensor may be located upstream and/or downstream of an aftertreatment system 150 for NOx reduction. It is contemplated that in certain embodiments the NOₓ sensor may additionally provide for oxygen detection.

It shall be appreciated that the foregoing sensors and sensor arrangements are but several non-limiting, illustrative embodiments of sensors and sensor systems to which the principles and techniques disclosed herein may be applied. A variety of other types of sensors and sensor configurations may be utilized including EGR flow sensors, boost pressure sensors, transmission sensors, and/or exhaust temperature sensors to name but a few examples. It shall further be appreciated that the sensors which are utilized may be physical sensors, virtual sensors and/or combinations thereof.

The internal combustion engine system 100 includes a controller 140 structured to perform certain operations to receive and interpret signals from any component and sensor of the air handling system 100. It shall be appreciated that the controller 140, or control module, may be provided in a variety of forms and configurations including one or more computing devices forming a whole or part of a processing subsystem having non-transitory memory storing computer executable instructions, processing, and communication hardware. The controller 140 may be a single device or a distributed device, and the functions of the controller 140 may be performed by hardware or instructions encoded on a computer readable medium. The controller 140 is in communication with any actuators, sensors, datalinks, computing devices, wireless connections, or other devices to be able to perform any described operations.

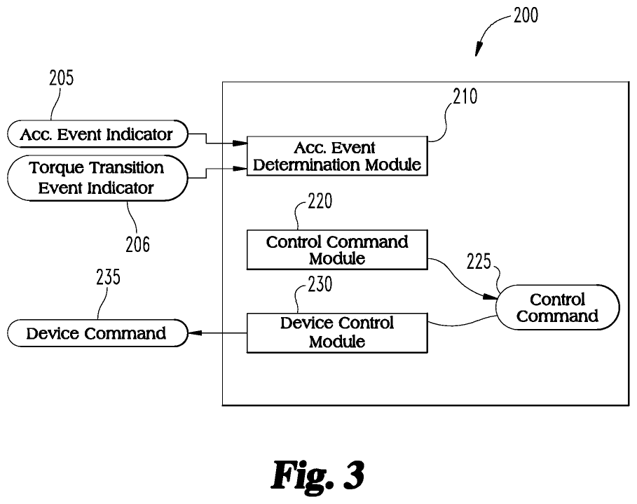

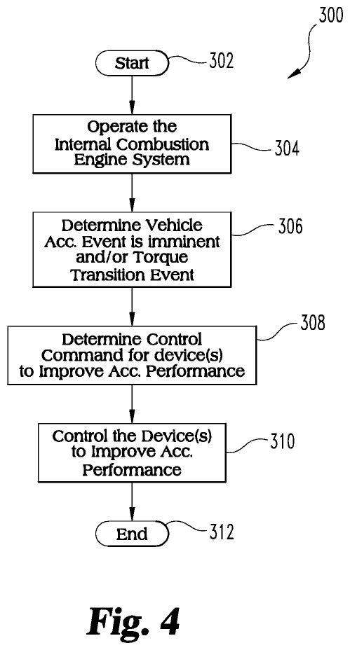

The controller 140 includes stored data values, constants, and functions, as well as operating instructions stored on computer readable medium. Any of the operations of exemplary procedures described herein may be performed at least partially by the controller. Other groupings that execute similar overall operations are understood within the scope of the present application. Modules may be implemented in hardware and/or software on one or more computer readable media, and modules may be distributed across various hardware or software components. More specific descriptions of certain embodiments of controller operations are discussed herein in connection with FIGS. 3-4. Operations illustrated are understood to be exemplary only, and operations may be combined or divided, and added or removed, as well as re-ordered in whole or in part.

Certain operations described herein include operations to interpret or determine one or more parameters. Interpreting or determining, as utilized herein, includes receiving values by any method, including at least receiving values from a datalink or network communication, receiving an electronic signal (e.g., a voltage, frequency, current, or pulse-width modulation (PWM) signal) indicative of the value, receiving a software parameter indicative of the value, reading the value from a memory location on a computer readable medium, receiving the value as a run-time parameter by any means known in the art, and/or by receiving a value by which the interpreted or determined parameter can be calculated, and/or by referencing a default value that is interpreted or determined to be the parameter value.

The controller 140 is operatively coupled with and structured to store instructions in memory which are readable and executable by the controller 140 to operate one or more devices of system 100 for improved acceleration performance, such as air and/or fuel handling actuators, including the LP EGR control valve 126, the HP EGR control valve 184, the intake throttle 139, a controllable inlet or wastegate 137 of turbine 134, the exhaust throttle 148, the spark timing of a spark plug, a fuel injection timing/amount, a start-up of an auxiliary load such as an air conditioner, and a turbocharger such as an electronic turbocharger to boost the charge flow pressure, for example. In one embodiment, controller 140 controls a position of one or more air handling valves and/or throttles by being operatively coupled with the associated one or more of LP EGR control valve actuator 126a, the HP EGR control valve actuator 184a, the intake throttle actuator 139a, the controllable turbine inlet or wastegate actuator 137a, and the exhaust throttle actuator 148a associated with respective ones of the LP EGR control valve 126, the HP EGR control valve 184, the intake throttle 139, the controllable turbine inlet or wastegate 137, and the exhaust throttle 148. In one embodiment, controller 140 controls starting-up, timing, or positioning of one or more of a turbocharger, an auxiliary load (such as an air conditioner), a fuel injector, and a spark plug.

One example embodiment of a controller arrangement including controller 140 is shown in FIG. 3. Controller 140 includes a control apparatus 200 including an acceleration event determination module 210 configured to determine at last one of an imminent vehicle acceleration event and a torque transition event in response to inputs such as a vehicle acceleration event indicator 205 and a shift event indicator 206. Control apparatus 200 also includes a control command module 220 configured to determine one or more control commands 225 for one or more devices of system 100, such as one or more actuators, injectors, spark plugs, turbocharger, throttles, valves, auxiliary loads, etc., that control an acceleration performance of the vehicle in response to the imminent vehicle acceleration event and/or shift event. Control apparatus 200 also includes a device control module 230 configured to control the one or more devices of the system 100 relative to a current state of the one or more devices in response to the one or more control commands to improve the acceleration performance for the imminent vehicle acceleration event and/or shift event.

In one embodiment, controller apparatus 200 receives operating signals from the various sensors 142, 144, 146 associated with a vehicle acceleration event indicator 205 and determines that a vehicle acceleration event is imminent. In one embodiment, controller apparatus 200 also or alternatively receives operating signals from the various sensors 142, 144, 146 associated with a torque transition indicator 206 and determines that a torque transition event is imminent. The operating signals can include a number of inputs representing received signals from various sensors 142, 144, 146 associated with the internal combustion engine system 100 described in FIG. 1. Example inputs can include one or more of an accelerator pedal position, an accelerator pedal pressure, a service brake pedal position, a service brake pedal pressure, a signal on a CAN bus of controller 140 regarding brake pedal position/pressure, a signal on a CAN bus of controller 140 associated with a gear change or shift event, a gear shift signal, a torque limit/control signal, a no load state of the engine, an engine speed input, a vehicle speed, a stability control signal, or a traction control signal, for example. Other possible inputs may include an engine out air-fuel ratio (AFR) input, a charge air flow input, an EGR flow input (LP EGR flow and/or HP EGR flow input), an EGR fraction input, an oxygen level input, a mass air flow input, an ambient air temperature input, an ambient air pressure input, an engine out NOx input, an intake manifold pressure input, an exhaust manifold pressure input, and a compressor flow rate input. It is contemplated that inputs to controller 140 can come from sensors, virtual or real, and/or be calculated and/or estimated based on, for example, other sensors and/or engine operating conditions. It is further contemplated that the inputs described herein are exemplary only, and certain embodiments may contain fewer, additional and/or alternative inputs.

The acceleration event determination module 210 is configured to receive and interpret inputs to the controller 140 from vehicle acceleration event indicator signals 205 and or torque transition event indicator signals 206. In an example embodiment, the acceleration event determination module 210 is further configured to determine a vehicle acceleration event is imminent and/or a torque transition is about to occur based at least in part on the inputs provided by vehicle acceleration event indicators 205 and/or torque transition indicators 206, and provide an output that the vehicle acceleration event is imminent to control command module 220.

The control command module 220 can provide a control command 225 to control one or more devices of the system 100 to improve a lug-up or acceleration performance relative to that which would occur based on a current position or state of the one or more devices. The device control module 230 provides a device command 235 to the one or more devices to provide the desired start-up, position, injection or timing to improved acceleration performance of the vehicle from launch or from a gear change.

The schematic flow diagram in FIG. 4 and related description which follows provides an illustrative embodiment of performing procedures for controlling the internal combustion engine system 100 in response to an imminent vehicle acceleration event and/or torque transition event to improve vehicle acceleration. Operations illustrated are understood to be exemplary only, and operations may be combined or divided, and added or removed, as well as re-ordered in whole or part. Certain operations illustrated may be implemented by a computer executing a computer program provided on a non-transitory computer readable storage medium, where the computer program comprises instructions causing the computer to execute one or more of the operations, or to issue commands to other devices to execute one or more of the operations.

Example procedure 300 for controlling the devices of system 100 to improve vehicle acceleration performance may be implemented in controller 140, for example. Procedure 300 begins at operation 302 which may begin by interpreting a key-on event and/or by initiation by an operator or technician. Operation 302 may alternatively or additionally include interpreting a communication or other parameter indicating that operation of a sampling interval is going to re-start procedure 300 upon completion of procedure 300.

Procedure 300 continues from operation 302 to operation 304, which includes operating the system 100. Procedure 300 continues at operation 306 to determine a vehicle acceleration event is imminent, such as in response to a vehicle acceleration event indicator, and/or a torque transition event in response to a torque transition indicator. Procedure 300 continues from operation 306 at operation 308 to determine one or more control commands for one or more devices of the system 100 that control an acceleration performance of the vehicle in response to the imminent vehicle acceleration event and/or torque transition event. Procedure 300 continues from operation 308 at operation 310 to control the one or more devices of the system in response to the one or more control commands to improve the acceleration performance for the imminent vehicle acceleration event and/or torque transition event relative to a current state of the one or more actuators.

In one embodiment, determining the one or more control commands at operation 308 includes determining one or more feedforward references for the one or more devices in response to the vehicle acceleration event and/or torque transition event. The one or more feedforward references can, for example, change one or more of the following devices of system 100 from its current state: an EGR valve position, an intake throttle position, a spark timing, a fuel injection timing, an application of an auxiliary load, an exhaust throttle position, a turbocharger wastegate position, and a variable geometry turbocharger inlet position. In another embodiment, the one or more feedforward references initiate operation of a turbocharger, such as an electrically powered supercharger, to boost a charge flow pressure prior to vehicle acceleration.

In another embodiment, the vehicle acceleration event indicator at operation 306 includes a CAN bus vehicle acceleration signal. In another embodiment, the torque transition indicator at operation 306 includes a CAN bus transmission signal and/or a torque limit/control signal. In still another embodiment, the vehicle acceleration event indicator at operation 306 includes look ahead route data indicating a vehicle launch is eminent. The look ahead data can be provided by radar, cameras, GPS, telematics, or intelligent transportation system infrastructure. In still other embodiments, the vehicle acceleration event indicator at operation 306 includes one or more of a service brake pressure being less than a threshold amount, a service brake position being less than a threshold amount, a vehicle speed changing more than a threshold amount, an accelerator pedal position being more than a threshold amount, an engine load, and a gear status. The torque transition event, as used herein, is a transition from a given torque value to a lesser or zero torque value, followed by an increase back to the original torque value or some other higher torque value. The torque transition can occur from operation of a transmission, stability control device, traction control device, or other torque interrupting device on the vehicle, for example.

Various aspects of the present disclosure are contemplated. According to one aspect, a method includes operating a system including an internal combustion engine and an air handling system. The air handling system includes an exhaust system and an intake system. The intake system structured to provide a charge flow to the internal combustion engine, and the charge flow includes a fresh air flow and an EGR flow. The method further includes determining at least one of a torque transition event and an imminent vehicle acceleration event in response to a respective one of a torque transition event indicator and a vehicle acceleration event indicator; determining one or more control commands for one or more devices of the system that control an acceleration performance of the vehicle in response to the one of the torque transition event and the imminent vehicle acceleration event; and controlling the one or more devices of the system in response to the one or more control commands to improve the acceleration performance for the one of the imminent vehicle acceleration event and the torque transition event relative to a current state of the one or more actuators.

In one embodiment, the method includes determining one or more feedforward references for the one or more devices in response to the one of the torque transition event and the vehicle acceleration event. In a refinement of this embodiment, the one or more feedforward references change one or more of the following devices from the current state: an EGR valve position, an intake throttle position, a spark timing, a fuel injection timing, an application of an auxiliary load, an exhaust throttle position, a turbocharger wastegate position, and a variable geometry turbocharger inlet position. In another embodiment, the one or more feedforward references initiate operation of a turbocharger to boost a charge flow pressure.

In another embodiment, the vehicle acceleration event indicator includes a CAN bus vehicle acceleration signal. In yet another embodiment, the vehicle acceleration event indicator includes look ahead route data indicating a vehicle launch is eminent. In a refinement of this embodiment, the look ahead route data is determined from at least one of a radar and a camera.

In still another embodiment, the vehicle acceleration event indicator includes one or more of a service brake pressure, a service brake position, a vehicle speed, and an accelerator pedal position. In another embodiment, the torque transition event indicator includes one or more of a CAN bus transmission control signal, a torque limit/control signal, a gear shift signal, a no load state of the engine, a stability control signal, or a traction control signal, for example.

In yet another embodiment, the one or more control commands include closing an EGR valve. In still another embodiment, the one or more control commands include closing an inlet to a variable geometry turbine.

In another aspect of the present disclosure, a system includes an internal combustion engine and an air handling system including an exhaust system and an intake system. The intake system is structured to provide a charge flow to the internal combustion engine. The air handling system includes an EGR system connecting the intake system and the exhaust system. The air handling system includes a plurality of actuators for controlling at least one of the charge flow, an exhaust flow, and an EGR flow. The system also includes a controller operatively coupled with the air handling system and the internal combustion engine. The controller is configured to perform the following operations during operation of the engine: determine one of a torque transition event and an imminent vehicle acceleration event in response to a respective one of a torque transition indicator and a vehicle acceleration event indicator; determine one or more control commands for one or more devices of the system that control an acceleration performance of the vehicle in response to the one of the torque transition event and the imminent vehicle acceleration event; and control the one or more devices of the system in response to the one or more control commands to improve the acceleration performance for the one of the torque transition event and the imminent vehicle acceleration event relative to a current position of the one or more actuators.

In one embodiment, the one or more devices includes at least one of an EGR valve in the EGR system, an exhaust throttle in the exhaust system, an inlet to a variable geometry turbine, a fuel injector, a spark plug, and a turbocharger to boost a charge flow pressure.

In another embodiment, the vehicle acceleration event indicator includes one or more of a service brake pressure, a service brake position, a vehicle speed, an accelerator pedal position, and CAN bus vehicle acceleration signal.

In still another embodiment, the torque transition event indicator includes one or more of a CAN bus transmission control signal, a gear shift signal, a torque limit/control signal, a no load state of the engine, a stability control signal, or a traction control signal, for example.

According to another aspect of the present disclosure, an apparatus includes an electronic controller in operative communication with a plurality of sensors operable to provide signals indicative of operational parameters of a system. The system includes an engine and an air handling system operationally coupled to the engine. The air handling system including an exhaust system and an intake system connected by an EGR system. The intake system is structured to provide a charge flow to the engine. The electronic controller includes: an acceleration event determination module configured to determine one of a torque transition event and an imminent vehicle acceleration event in response to a respective one of a torque transition indicator and a vehicle acceleration event indicator; a control command module configured to determine one or more control commands for one or more devices of the system that control an acceleration performance of the vehicle in response to the one of the torque transition event and the imminent vehicle acceleration event; and a device control module configured to control the one or more devices of the system in response to the one or more control commands to improve the acceleration performance for the one of the torque transition event and the imminent vehicle acceleration event relative to a current position of the one or more actuators.

In one embodiment, the one or more devices includes at least one of an EGR valve in the EGR system, an exhaust throttle in the exhaust system, an inlet to a variable geometry turbine, a fuel injector, a spark plug, and a turbocharger to boost a charge flow pressure.

In another embodiment, the vehicle acceleration event indicator includes one or more of a service brake pressure, a service brake position, a vehicle speed, an accelerator pedal position, and CAN bus vehicle acceleration signal.

In still another embodiment, the torque transition event indicator includes one or more of a CAN bus transmission control signal, a gear shift signal, a no load state of the engine, a stability control signal, or a traction control signal, for example.

In yet another embodiment, the vehicle acceleration event indicator includes look ahead route data indicating a vehicle launch is eminent, and the look ahead route data is determined from at least one of a radar and a camera.

While the invention has been illustrated and described in detail in the drawings and foregoing description, the same is to be considered as illustrative and not restrictive in character, it being understood that only certain exemplary embodiments have been shown and described and that all changes and modifications that come within the spirit of the inventions are desired to be protected.

In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

What is claimed is:

1. A method comprising:
operating a system including an internal combustion engine and an air handling system, the air handling system including an exhaust system and an intake system, the intake system structured to provide a charge flow to the internal combustion engine, wherein the charge flow includes a fresh air flow and an exhaust gas recirculation (EGR) flow;
determining at least one of a torque transition event and an imminent vehicle acceleration event in response to a respective one of a torque transition event indicator and a vehicle acceleration event indicator;
determining one or more control commands for one or more devices of the system that control an acceleration performance of the vehicle in response to the one of the torque transition event and the imminent vehicle acceleration event; and
controlling the one or more devices of the system in response to the one or more control commands to improve the acceleration performance for the one of the imminent vehicle acceleration event and the torque transition event relative to a current state of the one or more actuators.

2. The method of claim 1, further comprising determining one or more feedforward references for the one or more devices in response to the one of the torque transition event and the vehicle acceleration event.

3. The method of claim 2, wherein the one or more feedforward references change one or more of the following devices from the current state: an EGR valve position, an intake throttle position, a spark timing, a fuel injection timing, an application of an auxiliary load, an exhaust throttle position, a turbocharger wastegate position, and a variable geometry turbocharger inlet position.

4. The method of claim 2, wherein the one or more feedforward references initiate operation of a turbocharger to boost a charge flow pressure.

5. The method of claim 1, wherein the vehicle acceleration event indicator includes a CAN bus vehicle acceleration signal.

6. The method of claim 1, wherein the vehicle acceleration event indicator includes look ahead route data indicating a vehicle launch is eminent.

7. The method of claim 6, wherein the look ahead route data is determined from at least one of a radar and a camera.

8. The method of claim 1, wherein the vehicle acceleration event indicator includes one or more of a service brake pressure, a service brake position, a vehicle speed, and an accelerator pedal position.

9. The method of claim 1, wherein the torque transition event indicator includes one or more of a CAN bus transmission control signal, a torque limit/control signal, a gear shift signal, a no load state of the engine, a stability control signal, and a traction control signal.

10. The method of claim 1, wherein the one or more control commands include closing an EGR valve.

11. The method of claim 1, wherein the one or more control commands include closing an inlet to a variable geometry turbine.

12. A system, comprising:
an internal combustion engine;
an air handling system including an exhaust system and an intake system, the intake system structured to provide a charge flow to the internal combustion engine, the air handling system including an exhaust gas recirculation (EGR) system connecting the intake system and the exhaust system, the air handling system including a plurality of actuators for controlling at least one of the charge flow, an exhaust flow, and an EGR flow;
a controller operatively coupled with the air handling system and the internal combustion engine;
wherein the controller is configured to perform the following operations during operation of the engine:
determine one of a torque transition event and an imminent vehicle acceleration event in response to a respective one of a torque transition indicator and a vehicle acceleration event indicator;
determine one or more control commands for one or more devices of the system that control an acceleration performance of the vehicle in response to the one of the torque transition event and the imminent vehicle acceleration event; and
control the one or more devices of the system in response to the one or more control commands to improve the acceleration performance for the one of the torque transition event and the imminent vehicle acceleration event relative to a current position of the one or more actuators.

13. The system of claim 12, wherein the one or more devices includes at least one of an EGR valve in the EGR system, an exhaust throttle in the exhaust system, an inlet to a variable geometry turbine, a fuel injector, a spark plug, and a turbocharger to boost a charge flow pressure.

14. The system of claim 12, wherein the vehicle acceleration event indicator includes one or more of a service brake pressure, a service brake position, a vehicle speed, an accelerator pedal position, and CAN bus vehicle acceleration signal.

15. The system of claim 12, wherein the torque transition event indicator includes one or more of a CAN bus transmission control signal, a gear shift signal, a torque limit/control signal, a no load state of the engine, a stability control signal, and a traction control signal.

16. An apparatus, comprising:
an electronic controller in operative communication with a plurality of sensors operable to provide signals indicative of operational parameters of a system, the system including an engine and an air handling system operationally coupled to the engine, the air handling system including an exhaust system and an intake system connected by an exhaust gas recirculation (EGR) system, the intake system structured to provide a charge flow to the engine, wherein the electronic controller includes:
an acceleration event determination module configured to determine one of a torque transition event and an imminent vehicle acceleration event in response to a respective one of a torque transition indicator and a vehicle acceleration event indicator;
a control command module configured to determine one or more control commands for one or more devices of the system that control an acceleration performance of the vehicle in response to the one of the torque transition event and the imminent vehicle acceleration event; and
a device control module configured to control the one or more devices of the system in response to the one or more control commands to improve the acceleration performance for the one of the torque transition event and the imminent vehicle acceleration event relative to a current position of the one or more actuators.

17. The apparatus of claim 16, wherein the one or more devices includes at least one of an EGR valve in the EGR system, an exhaust throttle in the exhaust system, an inlet to a variable geometry turbine, a fuel injector, a spark plug, and a turbocharger to boost a charge flow pressure.

18. The system of claim 16, wherein the vehicle acceleration event indicator includes one or more of a service brake pressure, a service brake position, a vehicle speed, an accelerator pedal position, and CAN bus vehicle acceleration signal.

19. The system of claim 16, wherein the torque transition event indicator includes one or more of a CAN bus transmission control signal, a gear shift signal, a no load state of the engine, a stability control signal, and a traction control signal.

20. The apparatus of claim 16, wherein the vehicle acceleration event indicator includes look ahead route data indicating a vehicle launch is eminent, and the look ahead route data is determined from at least one of a radar and a camera.
